(19) United States
(12) Patent Application Publication
(10) Pub. No.: US 2008/0143910 A1
(43) Pub. Date: Jun. 19, 2008

(54) Liquid crystal display having special thin film transistor structure

(75) Inventor: Yung-Chiang Cheng, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/002,363

(22) Filed: Dec. 17, 2007

(30) Foreign Application Priority Data
Dec. 15, 2006 (TW) 95147249

(51) Int. Cl. G02F 1/136

(52) U.S. Cl. 349/46

(57) ABSTRACT

An exemplary liquid crystal display (LCD) includes two substrates (21), and a liquid crystal layer (22) sandwiched between the two substrates. One of the substrates includes a number of gate lines (201) parallel to each other, a number of data lines (202) parallel to each other and perpendicular to the gate lines, a number of pairs of first and second shield metal lines (206, 207), each first and second shield metal line arranged at two opposite sides of a data line; and a number of metal lines (2031) arranged between the corresponding second shield metal lines and the corresponding adjacent data lines. The data lines, the metal lines and the second shield metal lines define a plurality of thin film transistors (203), in which the data lines functioned as source electrodes, the metal lines functioned as the gate electrodes, and the second shield metal lines functioned as the drain electrodes.

### FIELD OF THE INVENTION

The present invention relates to a liquid crystal display (LCD), and particularly to an LCD having a unique thin film transistor structure for improving an aperture ratio of the LCD.

### GENERAL BACKGROUND

A typical LCD has the advantages of portability, low power consumption, and low radiation. LCDs have been widely used in various portable information products, such as notebooks, personal digital assistants (PDAs), video cameras and the like. Furthermore, the LCD is considered by many to have the potential to completely replace CRT (cathode ray tube) monitors and televisions.

Referring to FIG. 4, a typical LCD 1 includes a color filter (CF) substrate 10, a thin film transistor (TFT) substrate 11, and a liquid crystal layer 12 sandwiched between the two substrates 10, 11.

Referring also to FIG. 5, the TFT substrate 11 includes a number of gate lines 101 parallel to each other, a number of data lines 102 parallel to each other and perpendicular to the gate lines 101, and a number of common lines 105 adjacent and parallel to the gate lines 101 respectively. The gate lines 101 and data lines 102 cross each other, and thereby define a number of pixel regions (not labeled). In each pixel region, the TFT substrate 11 further includes a thin film transistor (TFT) 103, and a pixel electrode 104 connected to the TFT 103, and a pair of shield metal lines 106, 107 located at two opposite sides of the pixel electrode 104 respectively. The shield metal lines 106, 107 are parallel to the data lines 102, and are respectively disposed between the pixel electrode 104 and the two corresponding data lines 102.

The TFT 103 is provided in the vicinity of a respective point of intersection of the gate lines 101 and the data lines 102. The TFT 103 includes a gate electrode 1031 connected to the gate line 101, a source electrode 1032 connected to the data line 102, and a drain electrode 1033 connected to the corresponding pixel electrode 104. The first and second shield metal lines 106, 107 are used for preventing light leakage between two adjacent pixel regions.

Referring also to FIG. 6, the TFT substrate 11 further includes a glass substrate 110, a gate insulation layer 111, a semiconductor layer 112, and a passivation layer 113. A TFT area 130, a display area 132, and a data line area 131 are sequentially defined along the TFT substrate 11 at each pixel region.

In each TFT area 130, the gate electrode 1031 of the TFT 103 is formed on the glass substrate 110. The gate insulation layer 111 is formed on the glass substrate 110, and covers the gate electrode 1031 of the TFT 103. The semiconductor layer 112 is formed on the gate insulation layer 111. The source electrode 1032 and the drain electrode 1033 of the TFT 103 are formed on the semiconductor layer 112. A channel 114 is formed between the source electrode 1032 and the drain electrode 1033, over the gate electrode 1031 of the TFT 103. During manufacturing of the TFT substrate 11, the channel 114 exposes part of the semiconductor layer 112. The passivation layer 113 is formed on the source electrode 1032, the exposed semiconductor layer 112, and part of the drain electrode 1033 adjacent to the channel 114.

In each data line area 131, the data line 102 is formed on the glass substrate 110 in a process of forming the source electrode 1032 and the drain electrode 1033 of the TFT 103. The passivation layer 113 is formed on the glass substrate 110, and covers the data line 102. The pair of shield metal lines 106, 107 is formed on the passivation layer 113 at two opposite sides of the data line 102.

The TFT 103 functions as a switching element in the pixel region, and is made from opaque material. This effectively decreases a size of the display area 132 of the pixel region, and accordingly an aperture ratio of the LCD 1 is reduced. In order to maximize the aperture ratio of the LCD 1, the TFT area 130 of each pixel region is made as small as practicable. Thus a width to length (W/L) ratio of the TFT 103 is small. Therefore when the TFT 103 works as a switching element in the pixel region, the TFT 103 may have a slow response speed. Accordingly, the LCD 1 has a slow response speed.

It is desired to provide an LCD which can overcome the above-described deficiencies.

### SUMMARY

In one preferred embodiment, an LCD includes a first substrate, a thin film transistor (TFT) substrate parallel to the first substrate, and a liquid crystal layer sandwiched between the two substrates. The TFT substrate includes a plurality of gate lines parallel to each other, a plurality of data lines parallel to each other and perpendicular to the gate lines, a plurality of pairs of first and second shield metal lines, and a plurality of metal lines. The first and second shield metal lines in each pair are arranged at two opposite sides of a corresponding one of the data lines respectively. Each metal line is arranged corresponding to a respective one of the second shield metal lines and the adjacent data line, and is connected to a corresponding one of the gate lines. The data lines, the metal lines and the second shield metal lines cooperate to define a plurality of thin film transistors (TFTs), with portions of the data lines serving as source electrodes of the TFTs, the metal lines serving as gate electrodes of the TFTs, and the second shield metal lines serving as drain electrodes of the TFTs.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is a side cross-sectional view of an LCD according to an exemplary embodiment of the present invention, the LCD including a TFT substrate.

FIG. 2 is an enlarged, top plan view of part of the TFT substrate of the LCD of FIG. 1.

FIG. 3 is an enlarged side cross-sectional view taken along line III-III of FIG. 2.

FIG. 4 is a side cross-sectional view of a conventional LCD, the LCD including a TFT substrate.

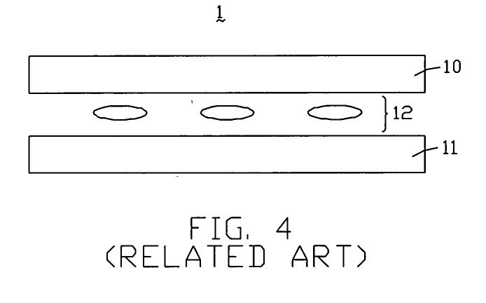

FIG. 5 is an enlarged, top plan view of part of the TFT substrate of the LCD of FIG. 4.

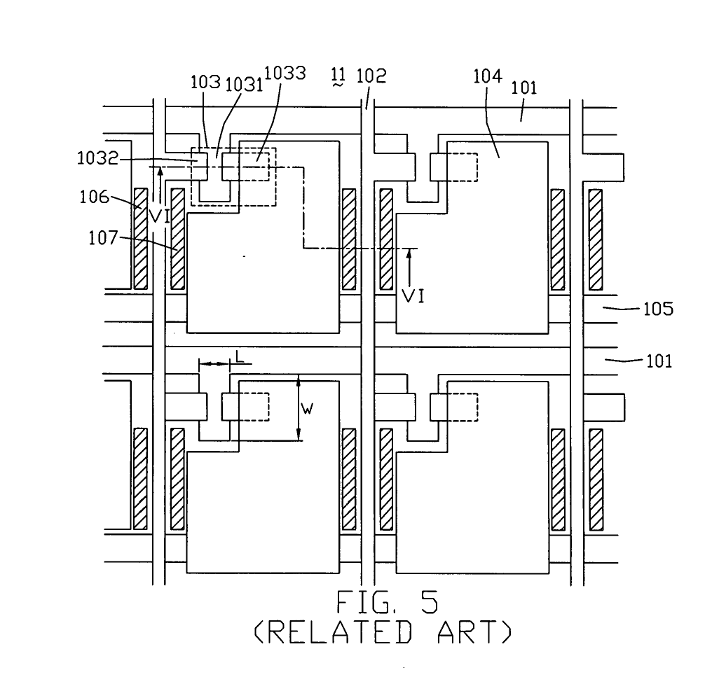

FIG. 6 is an enlarged, abbreviated cross-sectional view taken along line VI-VI of FIG. 4.

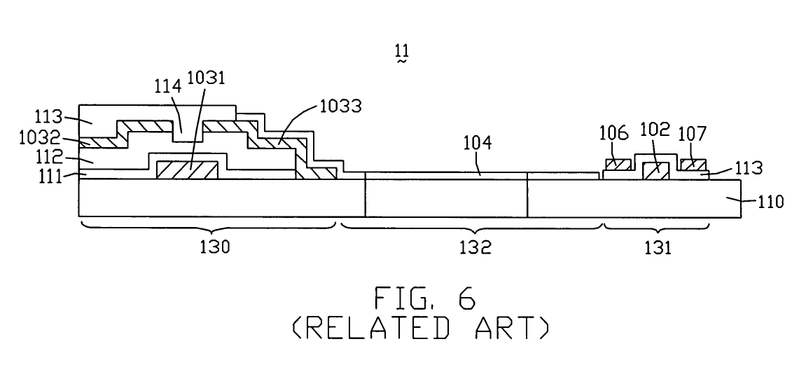

### DETAILED DESCRIPTION OF PREFERRED EMBODIMENTS

Reference will now be made to the drawings to describe various embodiments of the present invention in detail.

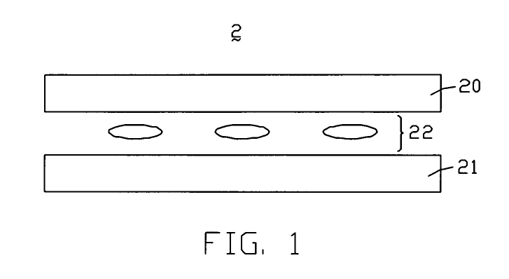

Referring to FIG. 1, an LCD 2 according to an exemplary embodiment of the present invention is shown. The LCD 2 includes a CF substrate 20, a TFT substrate 21 parallel to the CF substrate 20, and a liquid crystal layer 22 sandwiched between the two substrates 20, 21.

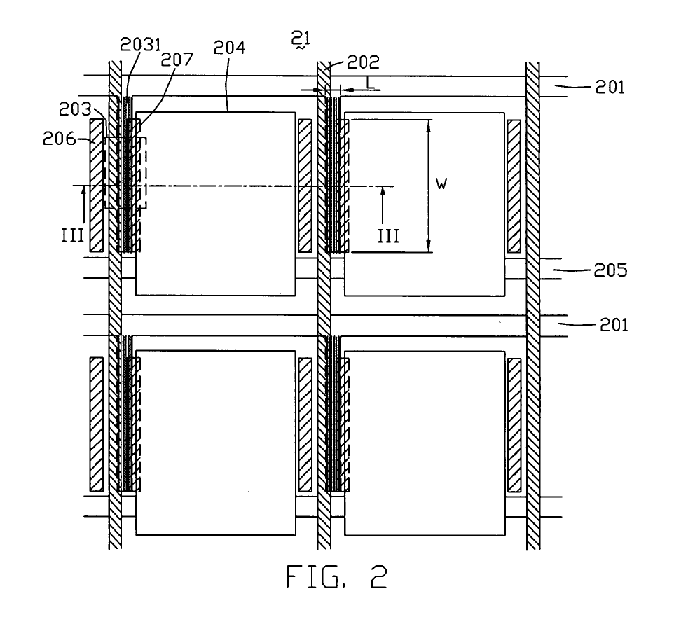

Referring also to FIG. 2, the TFT substrate 21 includes a number of gate lines 201 parallel to each other, a number of data lines 202 parallel to each other and perpendicular to the gate lines 201, and a number of common lines 205 adjacent and parallel to the gate lines 201 respectively. The gate lines 201 and data lines 202 cross each other, and thereby define a plurality of pixel regions (not labeled). In each pixel region, the TFT substrate 21 further includes a pixel electrode 204, a first shield metal line 206 and a second shield metal line 207 located at two opposite sides of the pixel electrode 204 respectively, and a metal line 2031 generally between the data line 202 and the second shield metal line 207. The first shield metal line 206, the second shield metal line 207, and the metal line 2031 are parallel to the data line 202. The metal line 2031 partly underlies both the data line 202 and the second shield metal line 207.

The first shield metal line 206 of each pixel region and the second shield metal line 207 of another adjacent pixel region adjacent to the first shield metal line 206 are respectively located at two opposite sides of the data line 202 that is sandwiched between the two adjacent pixel regions. The shield metal lines 206, 207 are used for preventing light leakage.

In each pixel region, parts of the data line 202, the metal line 2031, and the second shield metal line 207 define a TFT 203. The metal line 2031 is connected to the gate line 202, and is defined as a gate electrode of the TFT 203. The part of the data line 202 overlapping the metal line 2031 is defined as a source electrode of the TFT 203. The second shield metal line 207 is defined as a drain electrode of the TFT 203, and is connected to the corresponding pixel electrode 204.

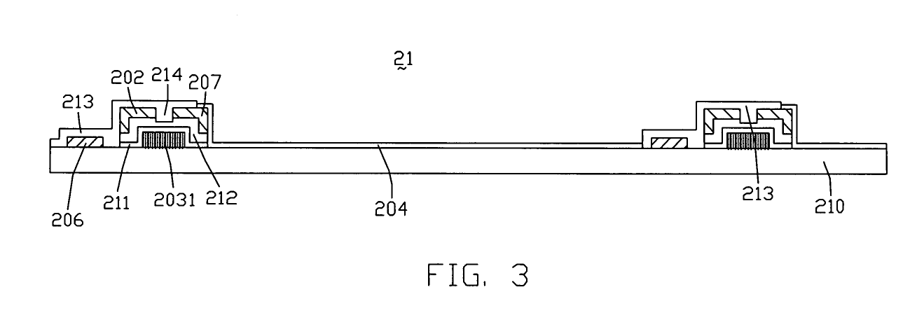

Referring also to FIG. 3, the TFT substrate 21 further includes a glass substrate 210, a gate insulation layer 211, a semiconductor layer 212, and a passivation layer 213.

In each pixel region, the gate line 201 (not shown in FIG. 3) and the metal line 2031 are formed on the glass substrate 210. The gate insulation layer 211 is formed on the glass substrate 210, and covers the gate line 201 and the metal line 2031. The semiconductor layer 212 is formed on the part of the gate insulation layer 211 over the metal line 2031. The data line 202 and the second shield metal line 207 are formed on the semiconductor layer 212. A channel 214 is formed between the data line 202 and the second shield metal line 207, over the metal line 2031 of the TFT 203. During manufacturing of the TFT substrate 21, the channel 214 exposes a corresponding part of the semiconductor layer 212. The first shield metal line 206 is formed on the glass substrate 210 in a process of forming the second shield metal line 207. The passivation layer 213 is formed on the glass substrate 210, and covers the data line 202, the exposed semiconductor layer 212 in the channel 214, a part of the second shield metal line 207 adjacent to the data line 202, and the first shield metal line 206.

In each pixel region, the pixel electrode 204 is formed on the glass substrate 210, and extends up one side of the TFT 203 to cover a part of the second shield metal line 207 far away from the data line 202 and connect with the passivation layer 213. The pixel electrode 204 fills substantially an entire area defined between the two adjacent data lines 202 and the two adjacent gate lines 201 of the pixel region.

The gate line 201 and the metal line 2031 can be made from metallic material selected from the group consisting of molybdenum, molybdenum alloy, aluminum-titanium alloy, and chrome. The first and second shield metal lines 206, 207 are made from material selected from the group consisting of molybdenum-tungsten alloy, chrome, and molybdenum.

In the LCD 2, each TFT 203 includes the gate electrode defined by the metal line 2031, the source electrode defined by part of the data line 202, and the drain electrode defined by the second shield metal line 207. Thereby, the TFT 203 can be positioned within a non-display area between the data line 202 and the second metal line 207, and a display area of each pixel region can be increased. Accordingly, an aperture ratio of the LCD 2 can be correspondingly increased. Furthermore, because the TFT 203 is located at the non-display area, a W/L ratio of the TFT 203 can be freely configured according to a desired response speed required of the TFT 203. Thus a response speed of the LCD 2 can be improved.

In an alternative embodiment, each second shield metal line 207 can be connected to the corresponding common line 205.

In another alternative embodiment, in each pixel region, the passivation layer 213 can be formed to cover the first shield metal line 206, the data line 202, the part of the semiconductor layer 212 in the channel 214, and all of the second shield metal line 207. The passivation layer 213 includes a number of through holes. The pixel electrode 204 is connected to the second shield metal line 207 via at least one of the through holes.

It is to be further understood that even though numerous characteristics and advantages of preferred and exemplary embodiments have been set out in the foregoing description, together with details of the structures and functions of the embodiments, the disclosure is illustrative only; and that changes may be made in detail, especially in matters of shape, size and arrangement of parts within the principles of the present invention to the full extent indicated by the broad general meaning of the terms in which the appended claims are expressed.

What is claimed is:

1. A liquid crystal display (LCD) comprising:
a first substrate;
a thin film transistor (TFT) substrate parallel to the first substrate, the TFT substrate comprising:
a plurality of gate lines parallel to each other;
a plurality of data lines parallel to each other and perpendicular to the gate lines;
a plurality of pairs of first and second shield metal lines, the first and second shield metal lines in each pair arranged at two opposite sides of a corresponding one of the data lines respectively; and
a plurality of metal lines, each metal line arranged corresponding to a respective one of the second shield metal lines and the adjacent data line, and being connected to a corresponding one of the gate lines; and
a liquid crystal layer sandwiched between the two substrates;
wherein the data lines, the metal lines and the second shield metal lines cooperate to define a plurality of thin film transistors (TFTs), with portions of the data lines serving as source electrodes of the TFTs, the metal lines serving as gate electrodes of the TFTs, and the second shield metal lines serving as drain electrodes of the TFTs.

2. The LCD as claimed in claim 1, wherein the TFT substrate further comprises a glass substrate, and the metal lines are formed at an inner side of the glass substrate.

3. The LCD as claimed in claim 2, wherein the TFT substrate further comprises a gate insulation layer formed on the glass substrate and covering the metal lines.

4. The LCD as claimed in claim 3, wherein the TFT substrate further comprises a semiconductor layer formed on the gate insulation layer.

5. The LCD as claimed in claim 4, wherein the data line and the second shield metal line of each TFT are formed on the semiconductor layer and partly overlap the metal line of the TFT, and a channel is defined between the data line and the second shield metal line, the channel spanning to a corresponding part of the semiconductor layer.

6. The LCD as claimed in claim 5, wherein the TFT substrate further comprises a passivation layer covering the first shield metal line, the data line, said corresponding part of the semiconductor layer at the channel, and a part of the second shield metal line.

7. The LCD as claimed in claim 6, wherein the TFT substrate further comprises a plurality of pixel electrodes respectively connected to the second shield metal lines.

8. The LCD as claimed in claim 7, wherein each pixel electrode substantially fills an entire area defined between two corresponding adjacent two data lines and two corresponding adjacent gate lines.

9. The LCD as claimed in claim 5, wherein the TFT substrate further comprises a passivation layer covering the first shield metal line, the data line, said corresponding part of the semiconductor layer at the channel, and the second shield metal line.

10. The LCD as claimed in claim 9, wherein the passivation layer comprises a plurality of through holes, and the TFT substrate further comprises a plurality of pixel electrodes respectively connected to the second shield metal lines via the through holes.

11. The LCD as claimed in claim 1, wherein the first shield metal lines and the second shield metal lines are made of the same material.

12. The LCD as claimed in claim 1, wherein the gate lines, the first shield metal lines, and the second shield metal lines are made from metallic material selected from the group consisting of molybdenum, molybdenum alloy, molybdenum-tungsten alloy, and chrome.

13. The LCD as claimed in claim 1, wherein the TFT substrate further comprises a glass substrate, and a plurality of common lines formed at the glass substrate adjacent and parallel to the gate lines respectively.

14. The LCD as claimed in claim 13, wherein the first shield metal lines are respectively connected to the common lines.

15. The LCD as claimed in claim 1, wherein the metal lines are made from material selected from the group consisting of chrome alloy, molybdenum alloy, aluminum-titanium alloy, and chrome.

16. A liquid crystal display (LCD) comprising:
a first substrate;
a thin film transistor (TFT) substrate parallel to the first substrate, the TFT substrate comprising:
a plurality of gate lines parallel to each other;
a plurality of data lines parallel to each other and perpendicular to the gate lines, the gate lines and data lines thereby defining a plurality of pixel regions, each pixel region comprising a pixel electrode, a first shield metal line, and a TFT, the TFT comprising a gate electrode defined by a metal line connected to a corresponding adjacent gate line, a source electrode defined by a part of a corresponding data line, and a drain electrode defined by a second shield metal line; and
a liquid crystal layer sandwiched between the two substrates;
wherein in each pixel region, the first and second shield metal lines are arranged at two opposite sides of the pixel electrode respectively, and the metal line is arranged generally between the second shield metal line and the data line.

17. The LCD as claimed in claim 16, wherein in each pixel region, the pixel electrode is connected to the second shield metal line.

18. The LCD as claimed in claim 16, wherein each pixel electrode substantially fills an entire area of the pixel region defined between the two adjacent data lines and the two adjacent gate lines.

19. A liquid crystal display (LCD) comprising:
a first substrate;
a thin film transistor (TFT) substrate parallel to the first substrate, the TFT substrate comprising:
a plurality of gate lines parallel to each other;
a plurality of data lines parallel to each other and perpendicular to the gate lines;
a plurality of metal lines parallel to data lines, each metal line partly underlying one corresponding adjacent data line and connecting to one corresponding adjacent gate line;
a plurality of first shield metal lines arranged at a side of the corresponding data line and parallel to the corresponding data line, with the first shield metal line partly overlapping the corresponding metal line; and
a liquid crystal layer sandwiched between the two substrates;
wherein portions of the data lines, the metal lines, and the first shield metal lines cooperatively form a plurality of TFTs.

20. The LCD as claimed in claim 19, wherein the TFT substrate further comprises a plurality of pixel electrodes respectively connected to the second shield metal lines, each pixel electrode substantially filling an entire area of a pixel region defined between two adjacent data lines and two adjacent gate lines.
